(19) United States
(12) Patent Application Publication
(10) Pub. No.: US 2004/0000775 A1
(43) Pub. Date: Jan. 1, 2004

(54) Inflatable curtain positioning tabs

(76) Inventors: David Henderson, Ogden, UT (US); Kurt Petersen, Wellsville, UT (US)

Correspondence Address: Sally J. Brown, Autoliv ASP, Inc., 3350 Airport Road, Ogden, UT, 84405, US

(21) Appl. No.: 10/188,251

(22) Filed: Jul. 1, 2002

(51) Int. Cl. B60R 21/22

(52) U.S. Cl. 280/730.2

(57) ABSTRACT

An inflatable curtain positioning system is disclosed that is inexpensive and does not require shape maintainers. The system includes an inflatable curtain prepared for installation in a vehicle. The inflatable curtain has a plurality of mounting members used to mount the inflatable curtain to a roof rail of a vehicle. The inflatable curtain, or sock housing the inflatable curtain, further includes a plurality of positioning members. The positioning members may engage the roof rail to optimally position portions of the inflatable curtain such that other components such as hand grips, and a vehicle headliner may be readily installed. The positioning members may permanently or temporarily position the inflatable curtain snug against the roof rail. The positioning members may be positioning tabs with holes to engage corresponding hooks formed in the roof rail. Alternatively, the positioning members may be a positioning loop formed in the sock. In another alternative, the positioning members are an adhesive material such as glue or two-sided tape.

### BACKGROUND OF THE INVENTION

1. The Field of the Invention

The present invention relates to airbag protection systems in motor vehicles. More specifically, the invention relates to an improved mechanism for positioning an inflatable curtain airbag within a vehicle.

2. Technical Background

Inflatable airbags are well accepted for use in motor vehicles and have been credited with preventing numerous deaths and injuries. In fact, the inclusion of inflatable safety restraint devices, or airbags, is now a legal requirement for many new vehicles. Airbags are typically installed throughout the passenger cabin of a vehicle, including the steering wheel. In the event of an accident, an accelerometer within the vehicle measures the abnormal deceleration and triggers the expulsion of rapidly expanding gases from an inflator. The expanding gases fill the airbags, which quickly inflate in front of the driver and passenger to protect them from impact against the windshield. Side impact airbags, such as curtain airbags, have also been developed in response to the need for protection from impacts in a lateral direction, or against the side of the vehicle.

Recently, airbag technology has advanced such that curtain airbags are now enlisted to provide roll-over protection as well as side impact protection. During a roll-over accident, occupants can be jostled considerably. Consequently, the occupant may be ejected from the vehicle. Alternatively, a head or limb of an occupant may extend outside the vehicle during the roll-over. “Occupant excursion” during roll-overs is a common cause of automotive fatality, particularly in the case of vehicle occupants that are not wearing a seat belt during the roll-over.

Conventional curtain airbags unfold or unroll downward to inflate beside a person to prevent the person from hitting the door or window during lateral impact. Since a vehicle occupant may be leaning forward, reclined in the seat, or at any position between, such airbags are typically long enough to cover the whole interior side of a vehicle, protecting occupants in both the front and rear passenger compartments.

To provide side impact and roll-over protection, curtain airbags are sized to hold large volumes of inflation gas and descend below the window sill. Consequently, when not inflated the curtain airbag includes a significant amount airbag material. Generally, this material is rolled or folded tightly into a long tubular bundle. When the curtain airbag is inflated, the curtain unrolls or unfolds along a side of the vehicle. The curtain may be kept rolled or folded by a sock which fits around the curtain.

To function properly, the curtain airbag is stored and mounted along a vehicle roof rail. When the curtain is inflated, the curtain breaks through the sock and descends. Inflation gas fills the curtain from the top of the vehicle toward the bottom. Typically, the curtain airbag is mounted to the roof rail by a plurality of cushion mount points. The mount points secure the curtain to the vehicle during deployment. For example, in certain curtains, an anchor mount point may be at each end, and intermediate mount points may be dispersed in between. Generally, the mount points are portions of the curtain airbag which extend through the sock. The mount points are often secured with bolts or other permanent fasteners.

Generally, the roof rail is as small and narrow as possible. The area inboard of the roof rail is also as small and narrow as possible to provide an appealing and spacious vehicle interior for occupants. Thus, area where an inflatable curtain is installed is very narrow. The inflatable curtain is typically concealed by interior trim panels and/or a headliner. The headliner is the material covering the interior roof. Typically, the headliner curves down along the sides of the roof and covers the roof rail. The edges of the headliner may be secured by door molding or the like.

The mount points secure the curtain to the roof rail. However, because the curtain and sock are flexible material, gravity causes the curtain to sag and droop between mount points. In addition, the contour and shape of the roof rail to which the curtain is mounted may cause the curtain to hang out away from the roof rail. Furthermore, besides the inflatable curtain, a number of various components need to be installed in and around the roof rail. These components compete for space in this narrow area along the roof rail. Examples of such components include, hand grips, lighting fixtures, sun or moon roof brackets, drain tubes, wiring, and heating and ventilation (HVAC) controls and ducts may be installed near the mounted inflatable curtain. The sagging, and drooping of the mounted curtain can interfere with the installation of these other components as well as the trim panels and headliner. Alternatively, the curtain may be pinched by the headliner or trim or be bunched up causing an unsightly bulge in the headliner.

To address these issues, plastic extruded shape maintainers have been developed. Generally, the shape maintainers are straight rigid members which are mounted to the roof rail between mount points. The shape maintainers have a ‘C’ shaped cross-section. The inflatable curtain is placed within the shape maintainer so that sagging and drooping does not interfere with the installation of other components.

Unfortunately, conventional shape maintainers have been hindered by a number of problems. The shape maintainer increases the number of parts in a vehicle. Each additional part has associated costs such as for material, manufacture, tooling, and design. The shape maintainer also adds to the vehicle weight. The rigid shape maintainer does not allow the curtain airbag to closely follow the contour of the roof rail. In addition, the rigid shape maintainer occupies valuable space near the roof rail. Finally, the use of a shape maintainer increases the installation time for the inflatable curtain.

Accordingly, it would be an advancement in the art to position the inflatable curtain in close proximity to the roof rail without the use of a shape maintainer. It would be a further advancement to provide an inflatable curtain positioning system that is flexible and sized to draw the inflatable curtain in close proximity to the roof rail while also accommodating other roof rail components. It would be another advancement in the art to provide an inflatable curtain positioning system that is less expensive to fabricate than conventional positioning systems. Additionally, it would be an advancement to provide an inflatable curtain positioning system that occupies minimal space near the roof rail. It would be another advancement in the art to provide an inflatable curtain positioning system that minimizes the installation time for the inflatable curtain. The present invention provides these advancements in a novel and useful way.

### BRIEF SUMMARY OF THE INVENTION

The apparatus of the present invention has been developed in response to the present state of the art, and in particular, in response to the problems and needs in the art that have not yet been fully solved by currently available inflatable curtain positioning systems. Thus, the present invention provides an inflatable curtain positioning system which is inexpensive to produce, minimizes parts, reduces assembly time, and occupies less space than conventional inflatable curtain positioning systems.

In one embodiment the inflatable curtain positioning system includes an inflatable curtain prepared for installation in a vehicle. The inflatable curtain may be prepared for installation by rolling, folding, or otherwise gathering the inflatable curtain into a long tubular shape. A mounting member extending from the inflatable curtain may be sized and positioned for mounting the inflatable curtain to a roof rail. Preferably, a plurality of mounting members extend from the inflatable curtain.

A positioning member may be connected to the inflatable curtain. The positioning member may be securable to the roof rail. When the position member is secured to the roof rail, the positioning member draws the inflatable curtain toward the roof rail. Additionally, a plurality of positioning members of various lengths and sizes may be disposed along the length of the inflatable curtain.

In another embodiment, the positioning system includes a sock that houses the inflatable curtain. Preferably, the sock is made of a flaccid fabric material. One or more positioning members may be integrated with the sock. The positioning members may be securable to the roof rail to draw the inflatable cushion snug against the roof rail. Each positioning member may have a different size and length for optimally positioning the inflatable curtain relative to the roof rail. Engagement of the positioning member may change the orientation of the inflatable curtain relative to the roof rail.

In certain embodiments, the positioning member includes a positioning tab having a hole shaped to engage a corresponding hook formed in the roof rail. Alternatively, the positioning member may comprise a positioning loop formed in the sock. The loop may engage a hook extending from the roof rail. Preferably, the positioning tab is flaccid being cut from the same material forming the sock.

In one embodiment, the positioning member permanently positions the inflatable curtain. Alternatively, the positioning member may temporarily position the inflatable curtain along the roof rail until a headliner and/or other components are installed. For example, the positioning member may be an adhesive material such as glue, two-sided tape, or the like. Alternatively, the positioning member may be corresponding portions of hook and loop material sold under the trademark VELCRO® which is a registered trademark of Velcro Industries B.V. Limited Liability Company, Netherlands.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages of the invention are obtained and may be readily understood, a more particular description of the invention briefly described above will be rendered by reference to specific embodiments thereof which are illustrated in the appended drawings. Understanding that these drawings depict only typical embodiments of the invention, and are not therefore to be considered to be limiting of its scope, the invention will be described and explained with additional specificity and detail through the use of the accompanying drawings in which:

FIG. 1 is a perspective view illustrating a curtain airbag mounted to a roof rail without using positioning members.

FIG. 2 is a perspective view illustrating one embodiment of the present invention including a sock, mounting member and positioning member.

FIG. 3 is a plan view of one embodiment of a sock which includes integrated positioning members.

FIG. 4 is a cross-section view illustrating one embodiment comprising a positioning member having a hole for engaging a corresponding hook in the roof rail.

FIG. 5A is a cross-section view illustrating an alternative embodiment for a positioning member which draws the curtain toward the roof rail.

FIG. 5B is a cross-section view illustrating an alternative embodiment for a positioning member comprising a positioning loop which draws and retains the curtain near the roof rail.

### DETAILED DESCRIPTION OF THE PREFERRED EMBODIMENTS

The present invention can be better understood with reference to the drawings where like parts are designated with like numerals throughout.

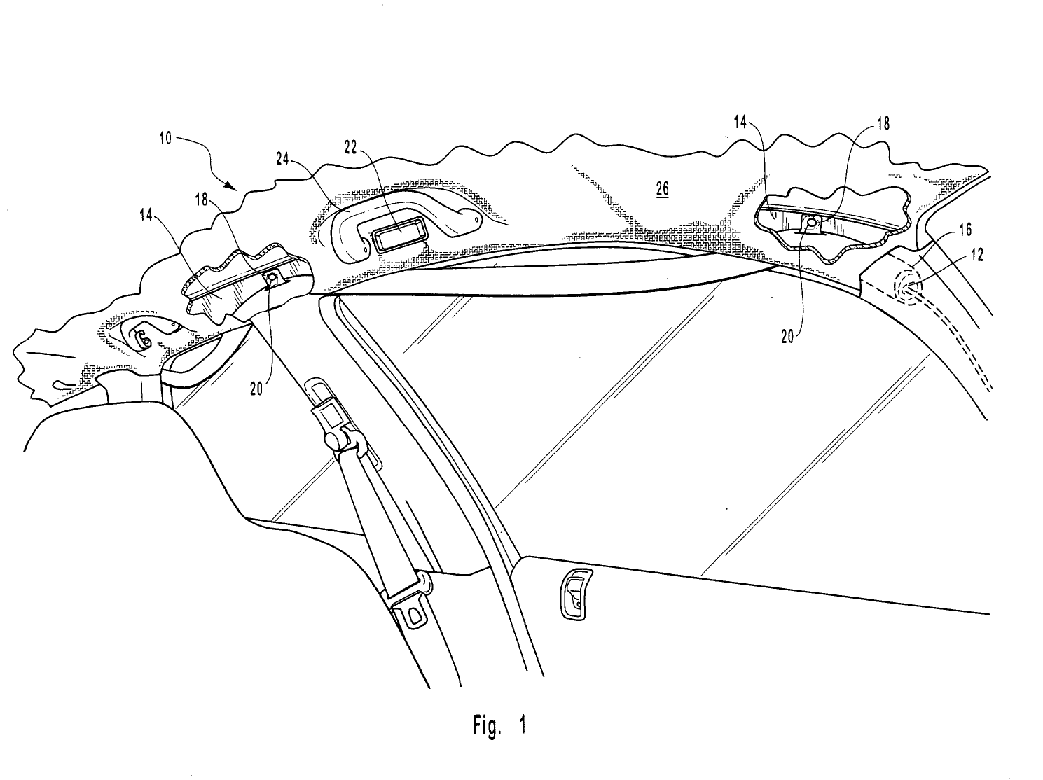

Referring now to FIG. 1, a side curtain airbag system 10 is illustrated. The system 10 includes a side inflatable curtain airbag 12. The inflatable curtain 12 includes an inflator (not shown) which provides inflation gas and a squib (not shown) which provides an initiation signal to initiate inflation of the inflatable curtain 12 when an accident occurs.

Generally, the inflatable curtain 12 is stored along a side roof rail 14 of a vehicle. The inflatable curtain 12 is sized to inflate and substantially cover the side windows and doors of a vehicle. However, the size of the roof rail 14 is generally kept to a minimum to provide an aesthetic vehicle interior and accommodate larger windows.

Therefore, to prepare an inflatable curtain 12 for installation in the small space inboard of the roof rail 14, the inflatable curtain 12 is folded, rolled, or otherwise gathered into a bundle having dimensions similar to those of the roof rail 14. The bundle may be held together for shipping to a vehicle assembly plant and installation in a vehicle by a housing 16. Generally, the housing 16 is a tubular sock. Preferably, the sock 16 is made from light-weight flexible semi-elastic material. The sock 16 is configured to break open longitudinally when the inflatable curtain 12 is inflated. The sock 16 keeps the inflatable curtain 12 operably contained within a bundle facilitating installation of the inflatable curtain 12 in a vehicle.

Generally, the inflatable curtain 12 is secured to the vehicle to ensure that the inflatable curtain 12 maintains a preferred position and orientation when the inflatable curtain 12 deploys down a side of the vehicle. Thus, the inflatable curtain 12 includes mounting members 18. The mounting members 18 may be integrated with the inflatable curtain 12. Alternatively, the mounting members 12 are securely attached to the inflatable curtain 12. The mounting members 18 anchor the inflatable curtain 12 to the vehicle to ensure the inflatable curtain 12 protects occupants throughout an accident.

Preferably, the mounting members 18 are tabs having holes 20 for receiving mounting bolts (not shown) which engage the roof rail 14. Of course the mounting members 18 may be secured to the roof rail 14 using other types of fasteners such as one-way push clips, rivets, or the like. Generally, a plurality of mounting members 18 are strategically positioned longitudinally along an upper edge of the inflatable curtain 12. The size and shape of the mounting members 18 depends on the design of the inflatable curtain 12.

Referring still to FIG. 1, once the inflatable curtain 12 is secured to the roof rail 14 by the mounting members 18, installation of the inflatable curtain 12 is nearly complete. Conventionally, the number of mounting members 18 is minimized. The number and positioning of the mounting member 18 generally allows the flexible inflatable curtain 12 and sock 16 to droop between mounting members 18. These drooping portions of the inflatable curtain 12 may interfere with the installation of other components near the roof rail 14.

For example, light fixtures 22, hand-grips 24, HVAC (heating and ventilation) controls, HVAC ducts, wiring, sun/moon roof brackets, and drainage tubes are a few types of components which are installed near the roof rail 14 depending on the make, model, and options for a particular vehicle. FIG. 1 illustrates only light fixtures 22, hand-grips 24 for clarity. Drooping portions of the inflatable curtain 12 may impede installation of these components. Workers or installation tools installing the components may inadvertently damage or pinch the inflatable curtain 12, rendering the inflatable curtain 12 inoperable.

Furthermore, a vehicle headliner 26 generally covers the roof of a vehicle. The edges of the headliner 26 descend to cover the area inboard of the roof rail 14. The drooping inflatable curtain 12 may impede securement of the edges of the headliner 26. Alternatively, the headliner 26 may be installed, but the drooping inflatable curtain 12 may cause an unsightly bulge along the edge of the headliner 26.

Conventionally, to reduce drooping and to position the inflatable curtain 12, a plastic extrusion referred to as a shape maintainer (not shown) is used. Generally, a shape maintainer is a rigid structure having a “C” shaped cross-section. The shape maintainer may be secured to the roof rail 14 to releasably engage a length of the inflatable curtain 12. Multiple shape maintainers may be used with an inflatable curtain 12. However, shape maintainers are separate parts which must be installed. The shape maintainers increase production costs and occupy valuable space inboard of the roof rail 14. The present invention overcomes several of the limitations of conventional shape maintainers.

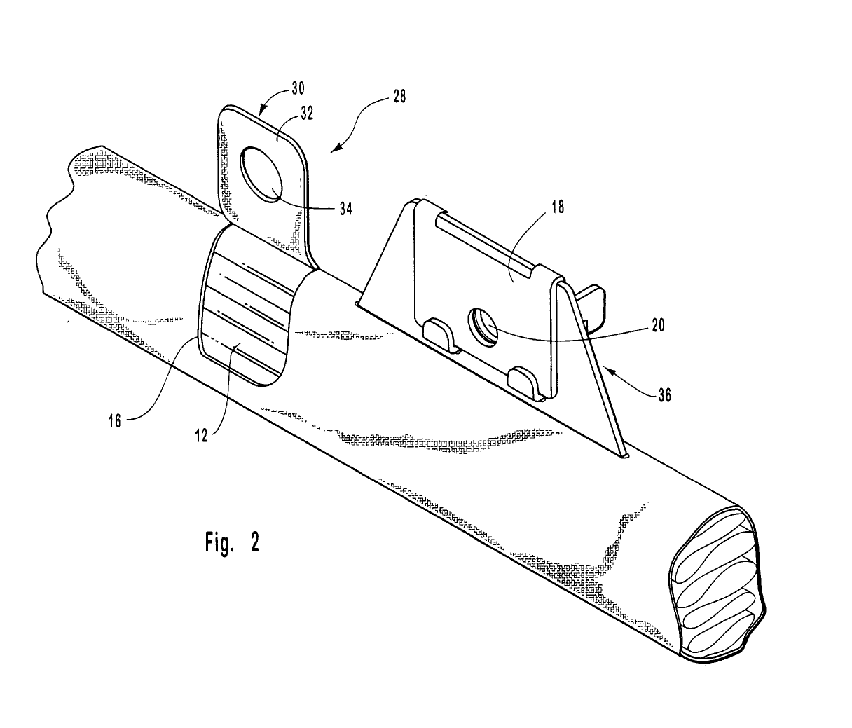

Referring now to FIG. 2, an inflatable curtain positioning system 28 according to one embodiment of the present invention is illustrated. The system 28 operably positions the inflatable curtain 12 and prevents drooping without shape maintainers. In addition to the inflatable curtain 12 and mounting member 18 described above, an inflatable curtain positioning system 28 includes a positioning member 30. The positioning member 30 connects the inflatable curtain 12 to the roof rail 14. Preferably, the positioning member 30 is connected to the inflatable curtain 12 such that engagement of the roof rail 14 draws the inflatable curtain 12 toward the roof rail 14.

The positioning member 30 may be connected directly to the inflatable curtain 12 or a sock 16 housing the inflatable curtain 12. The positioning member 30 may be integrated with the inflatable curtain 12 or sock 16. In the depicted embodiment, the positioning member 30 is cut from the material comprising the sock 16. Alternatively, the positioning member 30 may be connected to the inflatable curtain 12 or sock 16 using a variety of fasteners including stitches, staples, VELCRO®, an adhesive, or the like.

Generally, the inflatable curtain 12 includes a plurality of mounting members 18 and positioning members 30. The positioning members 30 may be disposed at various positions longitudinally along the inflatable curtain 30 or sock 16. The location of the positioning members 30, number of positioning members 30 used, and size of the positioning members 30 depends on the length and contour of the roof rail 14 and the position of other components to be installed near the inflatable curtain 12. Generally, a sufficient number of positioning members 30 are sized and positioned such that when each positioning member 30 engages the roof rail 14, the inflatable curtain 12 is drawn snug against the roof rail 14.

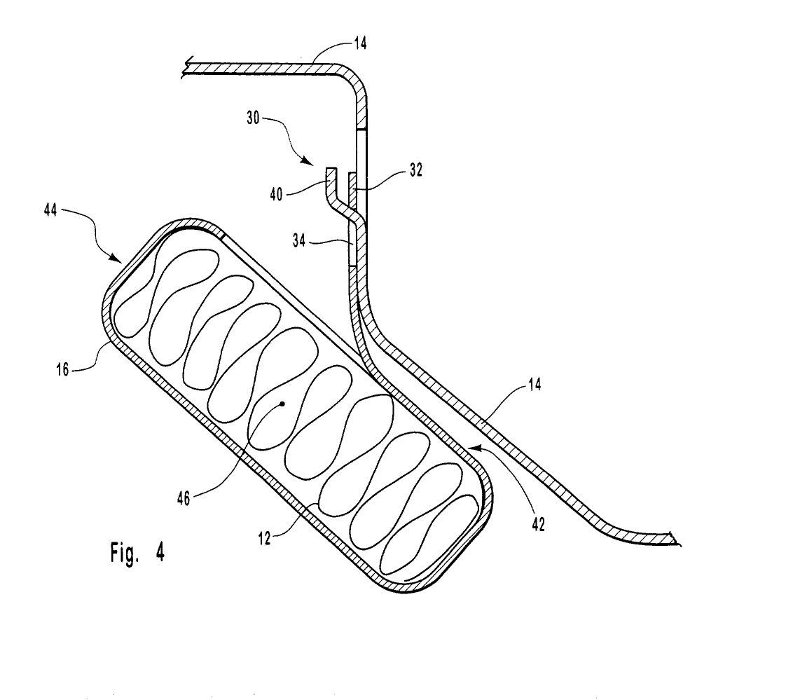

Preferably the positioning member 30 is a positioning tab 32 having a hole 34. The hole 34 is sized and shaped to engage a corresponding hook (as shown in FIG. 4) formed in the roof rail 14. The width and length of the positioning tab 32 are such that the sock 16 or inflatable curtain 12 is operably positioned and retained in close proximity to the roof rail 14. Engagement of the positioning tab 32 and the hook draws the inflatable curtain 12 towards the roof rail 14. Thus, drooping and sagging of the inflatable curtain 12 is prevented.

In the depicted embodiment, the mounting member 18 extends through the sock 16 housing the inflatable curtain 12. The mounting member 18 includes a hanger 36 having a hook for engaging the roof rail 14. The hanger 36 may be made from rigid plastic. The hanger 36 serves to temporarily mount the inflatable curtain 12 until a mounting fastener is used to permanently secure the mounting member 18 to the roof rail 14.

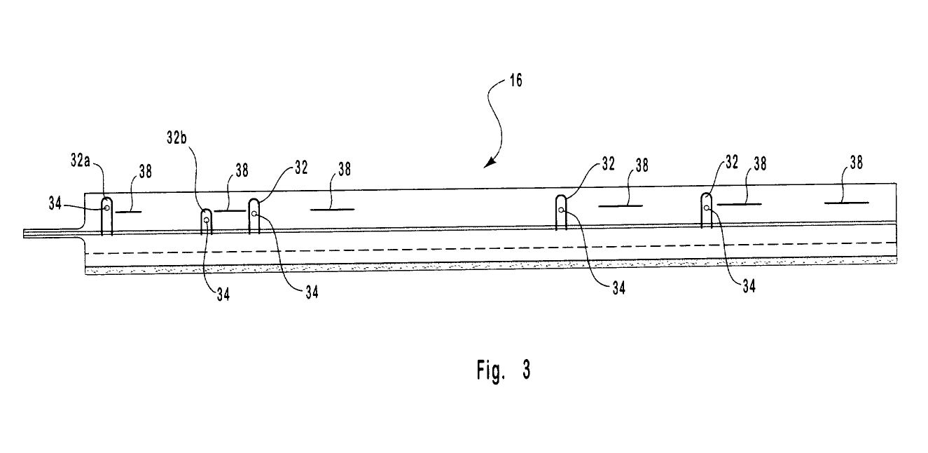

Referring now to FIG. 3, a sock 16 comprising a plurality of positioning members 30 in the form of positioning tabs 32 is illustrated. The sock 16 is illustrated lying flat. The longitudinal edges of the sock 16 are joined to form the tubular sock 16. Generally, the sock 16 is a fabric material having slits 38 to allow passage of a plurality of mounting members 18.

Preferably, the sock 16 includes positioning tabs 32 cut from the sock material. The positioning tabs 32 and holes 34 may be cut using the same techniques used to form the slits 38. For example, the positioning tabs 32, holes 34, and slits 38 may be formed using a laser cutting machine which cuts according to a CAD design. Preferably, the holes 34 are sized to engage a plurality of corresponding hooks formed in the roof rail 14. By integrating the positioning tabs 32 with the sock 16, the sock 16 serves to retain the inflatable curtain 12 and position the inflatable curtain 12 relative to the roof rail 14.

Generally, a vehicle roof rail 14 is substantially straight. Therefore, positioning tabs 32 may be aligned along a predetermined longitudinal axis extending lengthwise along the sock 16. The positioning tabs 32 may be of equal lengths to proportionally draw the inflatable curtain 12 snug against the roof rail 14.

However, the contour of the roof rail 14 and/or position of other components installed near the roof rail 14 may require that a first portion of the inflatable curtain 12 be closer to the roof rail 14 than a second portion of the inflatable curtain 12. Accordingly, as illustrated in FIG. 3, the positioning tabs 32 may be of different lengths to accommodate different assembled positions for portions of the inflatable curtain 12 relative to the roof rail 14.

For example, a first positioning tab 32a may be longer than a second positioning tab 32b. Engagement of the first positioning tab 32a positions a first portion of the inflatable curtain 12 in a first assembled position. Engagement of the second positioning tab 32b positions a second portion of the inflatable curtain 12 in a second assembled position. The first and second assembled positions may be different distances from the roof rail 14 to accommodate a structure such as a light fixture.

The contour of the roof rail 14 and/or position of other components installed near the roof rail 14 may also impact where positioning tabs 32 are located longitudinally along the sock 16. Certain lengths of the sock 16 may include no positioning tabs 32. Other lengths, may have two or more positioning tabs 32 within a relatively short span.

FIG. 4 is a cross-section view of an inflatable curtain 12 positioned in close proximity to a roof rail 14 according to one embodiment of the present invention. The inflatable curtain 12 is within a sock 16 which includes an integrated positioning tab 32. A corresponding hook 40 formed in the roof rail 14 extends to receive the hole 34 of the positioning tab 32.

The size, orientation, and configuration of the hook 40 is not crucial to the invention so long as the hook 40 operably retains the inflatable curtain 12 a predetermined distance from the roof rail 14. The hook 40 should also retain the inflatable curtain 12 even if the inflatable curtain 12 is bumped while other components are being installed.

The inflatable curtain 12 is operably positioned when the positioning tab 32 is made to engage the hook 40. In this manner, the positioning tab 32 draws the inflatable curtain 12 toward the roof rail 14. Preferably, the positioning tab 32 is located on the back side 42 of the inflatable curtain 12. Alternatively, the positioning tab 32 may be located on the top end 44. Generally, the position and length of the positioning tab 32 cause the inflatable curtain 12 to be positioned substantially parallel to the roof rail 14.

However, as seen in FIG. 4, a roof rail 14 may have a surface contour which curves. The contour and design of the roof rail 14 may be influenced by styling and structural integrity requirements. For example, the surface may curve below the hook 40. If the inflatable curtain 12 hangs straight below the hook 40, space may be wasted between the lower back side 42 and the roof rail 14.

Preferably, the positioning tab 32 is flaccid allowing the positioning tab 32 to bend and flex under the weight of the inflatable curtain 12. Some positioning tabs 32 may be located above the centroid 46 for the inflatable curtain 12. This positioning causes the inflatable curtain 12 to hang substantially parallel to the roof rail 14. Other positioning tabs 32 below the centroid 46 cause the inflatable curtain 12 to rotate about the centroid 46. When these positioning tabs 32 engage corresponding hooks 40, the orientation of the inflatable curtain 12 may be changed to more closely follow the surface contour of the roof rail 14. In this manner, the positioning tabs 32 draw the inflatable curtain 12 snug against the roof rail 14.

Generally, the purposes of the positioning members 30 is served once the headliner 26, trim panels, and other components (hand grips 24, light fixture 22, etc.) are installed. The time between when the inflatable curtain 12 is mounted and the headliner 26 and trim panels are installed may range from a few hours to a few days. Therefore, in certain embodiments, the positioning members 30 temporarily retains the inflatable curtain 12 and/or sock 16 in close proximity to the roof rail 14. However, positioning members 30 which retain the sock 16 for an extended period may be useful if the headliner 26 or trim panels are removed after assembly for vehicle maintenance or repair.

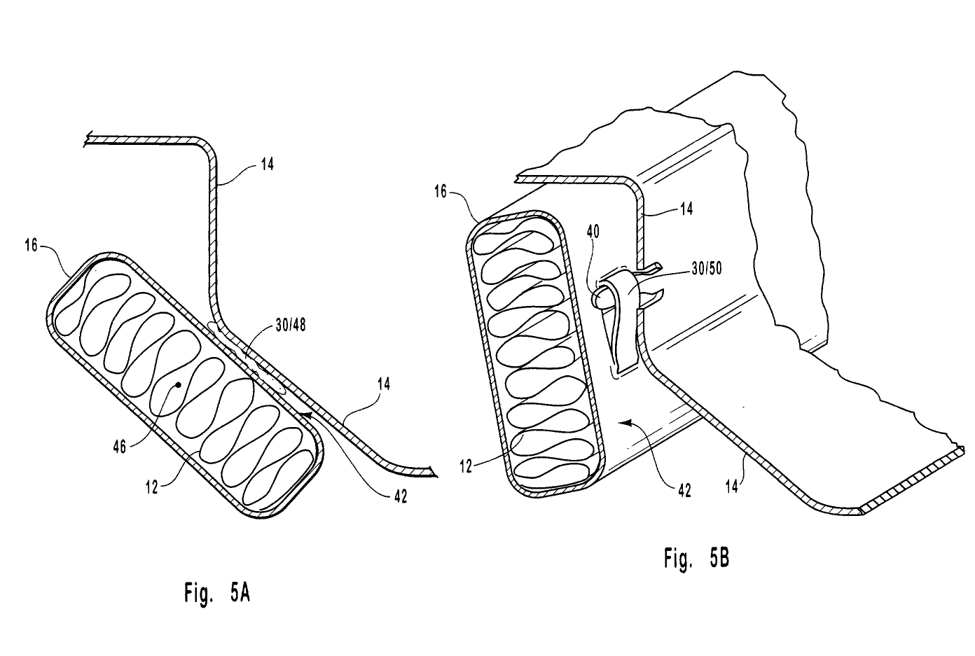

Referring now to FIG. 5A, an alternative positioning member 30 is illustrated in cross-section. The positioning member 30 may be an adhesive material 48. Preferably, the adhesive material 48 is applied to the back side 42 of the sock 16. The back side 42 of the sock 16 may then be pressed against the roof rail 14 to position and draw the inflatable curtain 12 toward the roof rail 14.

Of course a variety of adhesive materials 48 may be used. The adhesive material 48 may be glue, epoxy, silicon rubber, or the like. Preferably, the adhesive material 48 temporarily holds the inflatable curtain 12 in close proximity to the roof rail 14. Alternatively, the adhesive material 48 may retain the sock 16 for the expected life of the vehicle.

In one embodiment, the adhesive material 48 is two-sided adhesive tape. The adhesive tape may extend along the length of the back side 42 of the sock 16. Alternatively, sections of adhesive tape may be applied along the back side 42 where positioning of the inflatable curtain 12 is most desirable. In another embodiment, rather than two-sided tape, corresponding sections of VELCRO® may be used to position and retain the inflatable curtain 12.

FIG. 5B illustrates yet another embodiment for positioning members 30. The positioning member 30 may comprise a positioning loop 50. The positioning loop 50 is sized and positioned to engage a corresponding hook 40 formed in the roof rail 14.

Preferably, the positioning loop 50 is formed by cutting two parallel slits along the back side 42 of the sock 16. The slits are preferably perpendicular to a longitudinal axis of the inflatable curtain 12. Sock material between the slits may be pulled out to form the positioning loop 50. A transverse hook 40 may extend to engage the positioning loop 50.

Other variations of a positioning loop 50 are considered within the scope of the present invention. For example, a plurality of positioning loops 50 each of the same size may be disposed along the back side 42. Each positioning loop 50 may be shortened to a desirable length by twisting the positioning loop 50 prior to engaging the hook 40. Thus, each positioning loop 50 may draw a portion of the inflatable curtain 12 closer or further from the roof rail 14 depending on the number of twists placed in the positioning loop 50.

In summary, referring now generally to FIGS. 1-5B, an inflatable curtain positioning system 10 that is inexpensive and which does not use shape maintainers is provided. Positioning members 30 are preferably integrated into the inflatable curtain 12 or sock 16. The positioning members 30 engage corresponding hooks 40 formed in the roof rail 14 to draw the inflatable curtain 12 toward the roof rail 14. Preferably, the positioning members 30 are positioning tabs 32 disposed along the length of the sock 16. Alternatively, the positioning member 30 may be an adhesive material 48 or a positioning loop 50. The positioning members 30 may be designed to function temporarily of permanently.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. An inflatable curtain positioning system comprising:
an inflatable curtain prepared for installation in a vehicle;
a mounting member connected to the inflatable curtain to mount the inflatable curtain to a vehicle roof rail;
a positioning member connected to the inflatable curtain to draw the inflatable curtain toward the roof rail.

2. The inflatable curtain positioning system of claim 1, wherein the positioning member temporarily retains the inflatable curtain in close proximity to the roof rail.

3. The inflatable curtain positioning system of claim 1, wherein the positioning member comprises two-sided adhesive tape.

4. The inflatable curtain positioning system of claim 1, wherein the positioning member is a positioning tab, the positioning tab having a hole shaped to engage a corresponding hook formed in the roof rail.

5. The inflatable curtain positioning system of claim 1, wherein the positioning member is integrated with the inflatable curtain.

6. The inflatable curtain positioning system of claim 5, wherein the positioning member is a positioning loop, the positioning loop shaped to engage a corresponding hook formed in the roof rail.

7. The inflatable curtain positioning system of claim 1, wherein the positioning member changes the orientation of the inflatable curtain relative to the roof rail.

8. The inflatable curtain positioning system of claim 1, further comprising a plurality of positioning members disposed in the inflatable curtain, wherein a first positioning member is sized to position a first portion of the curtain to a first assembled position relative to the roof rail and a second positioning member is sized to position a second portion of the inflatable curtain to a second assembled position relative to the roof rail.

9. An inflatable curtain positioning system comprising:
a sock housing an inflatable curtain prepared for installation in a vehicle;
a mounting member that extends from the sock to mount the inflatable curtain to a vehicle roof rail;
a positioning member to draw the sock toward the vehicle roof rail.

10. The inflatable curtain positioning system of claim 9, wherein the positioning member is an adhesive material.

11. The inflatable curtain positioning system of claim 9, wherein the positioning member is integrated with the sock.

12. The inflatable curtain positioning system of claim 9, wherein the positioning member is a positioning tab, the positioning tab having a hole shaped to engage a corresponding hook formed in the roof rail.

13. The inflatable curtain positioning system of claim 9, wherein the positioning member is a positioning loop, the positioning loop shaped to engage a corresponding hook formed in the roof rail.

14. The inflatable curtain positioning system of claim 9, wherein the positioning member is integrated with the sock.

15. The inflatable curtain positioning system of claim 9, wherein the positioning member changes the orientation of the inflatable curtain relative to the roof rail

16. The inflatable curtain positioning system of claim 9, wherein the positioning member temporarily retains the inflatable curtain in close proximity to the roof rail.

17. The inflatable curtain positioning system of claim 9, further comprising a plurality of positioning members disposed longitudinally within the sock, wherein a first positioning member is sized to position a first portion of the curtain to a first assembled position relative to the roof rail and a second positioning member is sized to position a second portion of the inflatable curtain to a second assembled position relative to the roof rail.

18. The inflatable curtain positioning system of claim 9, wherein the positioning member draws the inflatable curtain snug against the roof rail.

19. An inflatable curtain positioning system comprising:
an inflatable curtain prepared for installation in a vehicle;
a sock surrounding the inflatable curtain;
a mounting tab extending from the inflatable curtain and passing through the sock, the mounting tab fixing the inflatable curtain to a vehicle roof rail; and
a positioning tab integrated with the sock, the positioning tab having a hole to engage a corresponding hook in the roof rail to position the inflatable curtain in close proximity to the roof rail.

20. An inflatable curtain positioning system, as in claim 19, wherein engagement of the positioning tab and the hook draws the sock toward the roof rail.

21. An inflatable curtain positioning system, as in claim 20, wherein the positioning tab is integrated with the sock.

22. An inflatable curtain positioning system, as in claim 21, wherein the positioning tab is flaccid.

23. An inflatable curtain positioning system, as in claim 22, further comprising a plurality of mounting tabs disposed in the inflatable curtain and a plurality of positioning tabs disposed in the sock, the plurality of positioning tabs having a plurality of corresponding hooks extending from the roof rail.

24. An inflatable curtain positioning system, as in claim 22, wherein the positioning tab is cut from material comprising the sock.

25. The inflatable curtain positioning system of claim 24, wherein the positioning member changes the orientation of the inflatable curtain relative to the roof rail

26. The inflatable curtain positioning system of claim 25, wherein the positioning member temporarily positions the inflatable curtain in substantially close proximity to the roof rail.

27. The inflatable curtain positioning system of claim 9, wherein the positioning member draws the inflatable curtain snug against the roof rail.
